(19) United States
(12) Patent Application Publication
(10) Pub. No.: US 2009/0019361 A1
(43) Pub. Date: Jan. 15, 2009

(54) METHODS, SYSTEMS, AND COMPUTER PROGRAM PRODUCTS FOR PROVIDING A BROWSING MODE ASSOCIATION OF A LINK WITH BROWSED CONTENT

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 11/776,867

(22) Filed: Jul. 12, 2007

(51) Int. Cl. G06F 15/00

(52) U.S. Cl. 715/255

(57) ABSTRACT

Methods and systems are described for providing a browsing mode association of a link with browsed content. In one aspect, content is received from a content provider for display via a user interface of a browser. A selection of at least a portion of the content is received while the user interface is operating in a browsing mode. An identifier of a resource is received via the user interface. The selected content is associated with the identifier to operate as a link for accessing the resource via the user interface. In another aspect, a first identifier is received from a browser for identifying at least a portion of content presented in the browser in a browsing mode. A second identifier is received for identifying a resource. The first and second identifiers are associated for enabling the at least a portion of the content to operate as a link for accessing the resource via the browser.

### BACKGROUND

When a browser displays content for a web resource such as a web page or a media entity such as an audio stream, a video stream, or an image; the links that are provided in the web resource are determined by the provider. Often a user will see something of interest in the browsed content, but there is no associated link for obtaining additional information. In other cases, a user may follow a link in the browsed content only to discover the resource associated with the link is not of interest, or worse is annoying or dangerous to the user's privacy and/or the security of the user's device.

Tools exist that allow for the creation of links in content while editing the content in an editing mode. This approach requires, however, the use of an appropriate editor and that the content and/or underlying resource is changed as a result of the edit. This approach can be used to edit content in a resource to include a link. There are, however, several disadvantages to this approach, including the fact that content providers typically do not allow viewers of the content to change their content (and will enforce such prohibitions using, for example, security rights management) and that content is not editable while it is being browsed, i.e., while viewed in a browsing mode.

Accordingly, there exists a need for methods, systems, and computer program products for providing a browsing mode association of a link with browsed content.

### SUMMARY

Methods and systems are described for providing a browsing mode association of a link with browsed content. In one aspect, content is received from a content provider for display via a user interface of a browser. A selection of at least a portion of the content is received while the user interface is operating in a browsing mode, wherein the selected at least a portion of the content cannot be changed via the user interface. An identifier of a resource is received via the user interface, wherein the resource is accessible via the browser but is not linked via the user interface to the portion of the content. The at least a portion of the content is associated with the identifier without changing the selected at least a portion of the content, thereby enabling the at least a portion of the content to operate as a link for accessing the resource via the user interface.

In another aspect, a first identifier is received from a browser for identifying at least a portion of content presented in the browser in a browsing mode. A second identifier for identifying a resource is received, wherein the resource is accessible via the browser but is not linked to the identified portion of the content. The first and second identifiers are associated for enabling the at least a portion of the content to operate as a link for accessing the resource via the browser.

In another aspect, a system for providing a browsing mode association of a link with browsed content includes: means for receiving content from a content provider for display via a user interface of a browser; means for receiving a selection of at least a portion of the content while the user interface is operating in a browsing mode, wherein the selected at least a portion of the content cannot be changed via the user interface; means for receiving an identifier of a resource via the user interface, wherein the resource is accessible via the browser but is not linked via the user interface to the portion of the content; and means for associating the at least a portion of the content with the identifier without changing the selected at least a portion of the content, thereby enabling the at least a portion of the content to operate as a link for accessing the resource via the user interface.

In another aspect, a system for providing a browsing mode association of a link with browsed content includes: a content interpreter component configured for receiving content from a content provider for display via a user interface of a browser; an input controller component configured for receiving a selection of at least a portion of the content while the user interface is operating in a browsing mode, wherein the selected at least a portion of the content cannot be changed via the user interface; the input controller component configured for receiving an identifier of a resource via the user interface, wherein the resource is accessible via the browser but is not linked via the user interface to the portion of the content; and a link service component configured for associating the at least a portion of the content with the identifier without changing the selected at least a portion of the content, thereby enabling the at least a portion of the content to operate as a link for accessing the resource via the user interface.

In another aspect, a system for providing a browsing mode association of a link with browsed content, the system comprising: means for receiving a first identifier from a browser for identifying at least a portion of content presented in the browser in a browsing mode; means for receiving a second identifier for identifying a resource, wherein the resource is accessible via the browser but is not linked to the identified portion of the content; and means for associating the first and second identifiers for enabling the at least a portion of the content to operate as a link for accessing the resource via the browser.

In another aspect, a system for providing a browsing mode association of a link with browsed content includes a network interface component configured for receiving a first identifier from a browser for identifying at least a portion of content presented in the browser in a browsing mode and configured for receiving a second identifier for identifying a resource, wherein the resource is accessible via the browser but is not linked to the identified portion of the content; and a link service component configured for associating the first and second identifiers for enabling the at least a portion of the content to operate as a link for accessing the resource via the browser.

In another aspect, a computer readable medium includes a computer program, executable by a machine, for providing a browsing mode association of a link with browsed content. The computer program includes executable instructions for: receiving content from a content provider for display via a user interface of a browser; receiving a selection of at least a portion of the content while the user interface is operating in a browsing mode, wherein the selected at least a portion of the content cannot be changed via the user interface; receiving an identifier of a resource via the user interface, wherein the resource is accessible via the browser but is not linked via the user interface to the portion of the content; and associating the at least a portion of the content with the identifier without changing the selected at least a portion of the content, thereby enabling the at least a portion of the content to operate as a link for accessing the resource via the user interface.

In another aspect, a computer readable medium includes a computer program, executable by a machine, for providing a browsing mode association of a link with browsed content. The computer program includes executable instructions for: receiving a first identifier from a browser for identifying at least a portion of content presented in the browser in a browsing mode; receiving a second identifier for identifying a resource, wherein the resource is accessible via the browser but is not linked to the identified portion of the content; and associating the first and second identifiers for enabling the at least a portion of the content to operate as a link for accessing the resource via the browser.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for providing a browsing mode association of a link with browsed content according to an aspect of the subject matter described herein;

FIG. 2 is block a diagram illustrating a system for providing a browsing mode association of a link with browsed content according to another aspect of the subject matter described herein;

FIG. 3 is block a diagram illustrating a system for providing a browsing mode association of a link with browsed content according to another aspect of the subject matter described herein;

FIG. 4 is message flow diagram illustrating exemplary message flow for providing a browsing mode association of a link with browsed content according to another aspect of the subject matter described herein;

FIG. 5 is a flow diagram illustrating a method for providing a browsing mode association of a link with browsed content according to another aspect of the subject matter described herein; and

FIG. 6 is a block diagram illustrating a system for providing a browsing mode association of a link with browsed content according to another aspect of the subject matter described herein.

### DETAILED DESCRIPTION

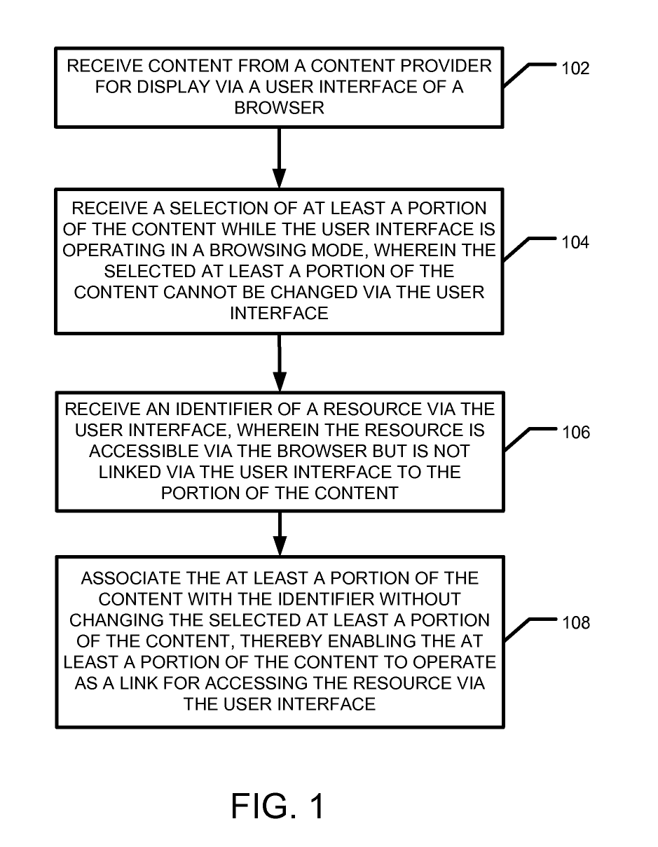

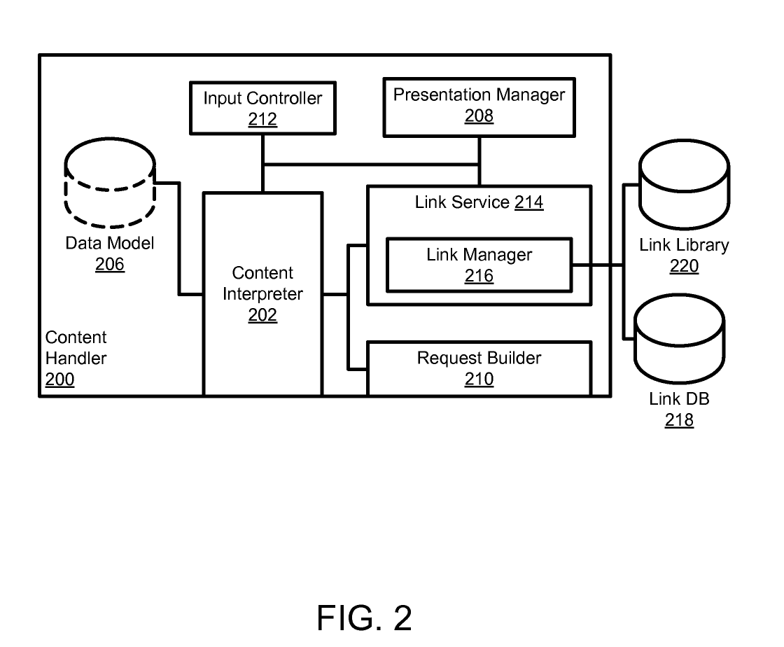

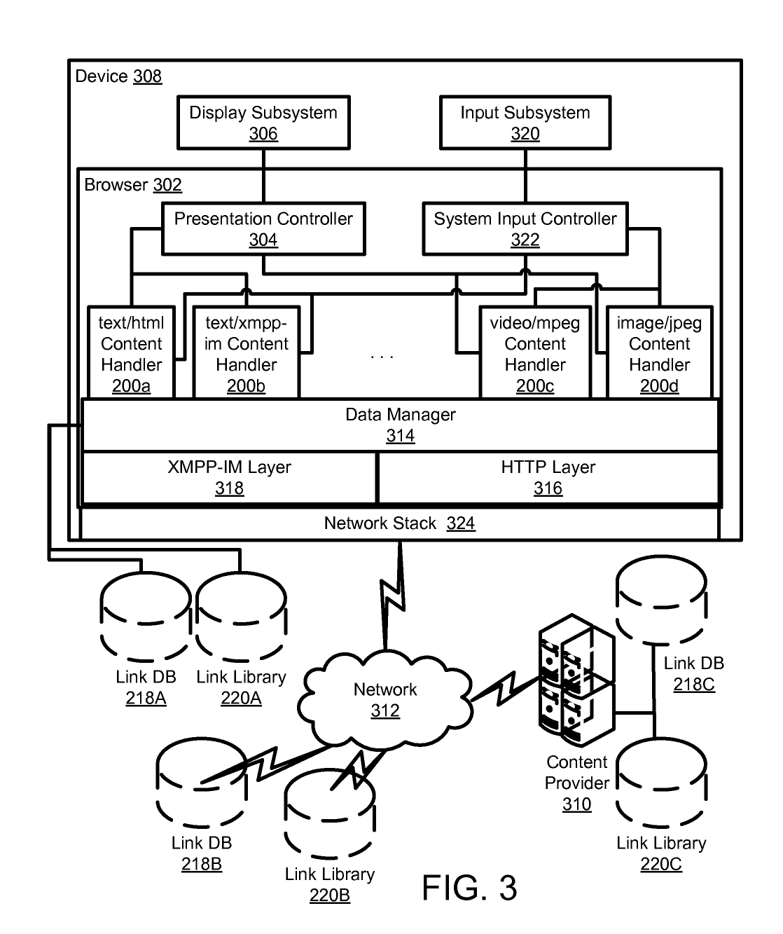

FIG. 1 is a flow diagram illustrating a method for providing a browsing mode association of a link with browsed content according to an exemplary aspect of the subject matter described herein. FIG. 2 is a block diagram illustrating a system for providing a browsing mode association of a link with browsed content according to another exemplary aspect of the subject matter described herein. FIG. 3 is a block diagram illustrating a system for providing a browsing mode association of a link with browsed content according to another exemplary aspect of the subject matter described herein. The method illustrated in FIG. 1 can be carried out by, for example, some or all of the components illustrated in the exemplary systems of FIGS. 2 and/or 3.

With reference to FIG. 1, in block 102, content is received from a content provider for display via a user interface of a browser. Accordingly, a system for providing a browsing mode association of a link with browsed content includes means for receiving content from a content provider for display via a user interface of a browser. For example, as illustrated in FIG. 2, a content interpreter component 202 is configured for receiving content from a content provider for display via a user interface of a browser.

FIG. 2 illustrates a content handler 200 that includes a content interpreter component 202 configured to receive content from a content provider (such as content provider 310 illustrated in FIG. 3). The content handler 200 processes the received content for display via a user interface of a browser, for example. Typically, the content handler 200 processes content of a particular type, typically indicated by a multipurpose internet mail extension (MIME) type indicator associated with the received content. Examples of received content types include text, hypertext markup language (HTML), extensible markup language (XML), extensible messaging and presence protocol for instant messaging (XMPP-IM), resource description framework (RDF), portable document format (PDF), video (e.g., moving pictures experts group (MPEG)), still image data (e.g., joint photographic experts group (JPEG)), and audio.

The content interpreter component 202 can process received content based on its type, which typically indicates the content's format implicitly. Alternatively, a format of the content can be specified explicitly through the association of one or more schemas defining valid elements and/or format of the content. Based on the format of the content, the content interpreter component 202 can construct a data model 206 of the content, such as a document object model (DOM) generated by content handlers that process various XML-based content types. Alternatively, the content interpreter component 202 can use implicit knowledge, for example, included in the instructions of the content interpreter component 202 and/or can generate portions of the data model 206 associated with received content as needed.

With reference also to FIG. 3, based on the content type, the actual content, and/or the data model 206, the content interpreter component 202 can provide a presentation manager component 208 with a representation of the content for providing the content to a browser, such as browser 302, for display by a presentation controller 304 of the browser 302. The presentation controller 304 interoperates with a display subsystem 306 included in the execution environment provided by a device 308. The display subsystem 306 is configured to interoperate with a display device, such as a display (not shown), for displaying a user interface of the browser based on the representation of the received content provided by the presentation manager component 208 of the content handler 200.

FIG. 3 also illustrates multiple content handlers 200 supporting a variety of content types in the browser 302 of device 308. Content handlers 200a-200d are shown for supporting exemplary content types text/html, text/xmpp-im, video/mpeg, and image/jpeg. Content can be received from the content provider 310 via a network 312, such as a local area network (LAN), wide area network (WAN), personal area network (PAN), wireless access network, cellular network, the Internet, and the like. Examples of content providers include a web server, a web application hosted by a web application container such as Java 2 platform, enterprise edition (J2EE), a file transfer protocol (FTP) server, a remote file system, and a publish-subscribe service such as a presence service. The content can be received unsolicited by the browser 302 and/or can be received as a result of a message including a request sent from the browser 302 to the content provider 310 via the network 312.

For example, a request can be initiated by a request builder component 210 of the content handler 200. Alternatively, a request generation can be initiated by a data manager 314 of the browser 302. The data manager 314 can, for example, interoperate with the request builder component 210 to determine the type of request and the protocol to be used. Based on the determination, request information is provided to a determined protocol layer, such as a hypertext transfer protocol (HTTP) layer 316 and/or an XMPP-IM layer 318 depicted in FIG. 3. The generation of the request can be triggered by the receipt of a uniform resource locator (URL) via a location bar presented in the browser user interface. The URL is received via an input subsystem 320 included in the execution environment of the device 308. The input subsystem 320 is operatively coupled to one or more input devices (not shown), such as a keyboard, a mouse, a four-way controller, a phone pad, a microphone, a gaze detector, and the like. The input subsystem 320 provides input information to a system input controller component 322 of the browser 302. The system input controller component 322 routes input information to one or more of the content handlers 200 for processing and/or routes input information to the data manager 314. The generation of the request can also be triggered by receiving an indication to activate a link presented by the browser 302 user interface. The indication is received via an input device (not shown) via the input subsystem 320 in a manner similar to that described above. When the request is generated, request information is provided to a protocol layer 316 and/or 318 that interoperates with a network subsystem of the execution environment of the device 308. The network subsystem includes, for example, a network stack 324. The protocol layer 316 and/or 318 sends a message including the request to the content provider 310 via the network stack 324 and the network 312.

The content interpreter component 202 receives content sent in a message from the content provider 310 over the network 312 via the network stack 324 operatively coupled to the network 312 by, for example, a network interface card (NIC). The network stack 324 communicates with a protocol layer 316 and/or 318 that passes content to the data manager 314. Based on the type of the content, the content is routed to a compatible content handler 200 where it is received by the content interpreter component 202 of the content handler 200 for display via the user interface of the browser 302, as described above.

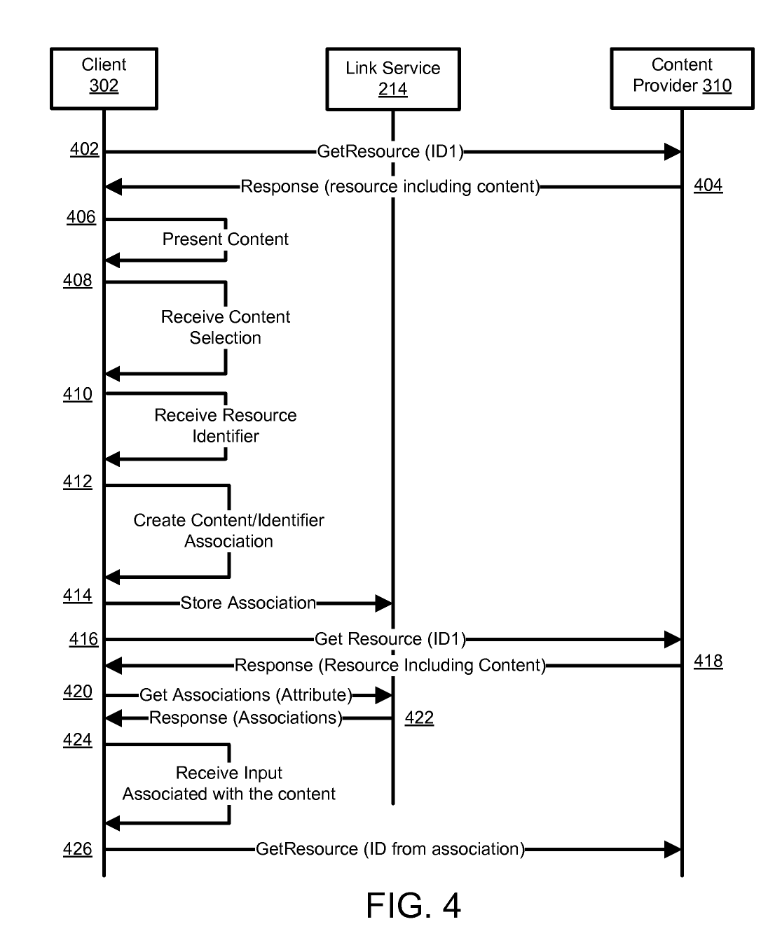

FIG. 4 is a message flow diagram illustrating messages according to another aspect of the subject matter described herein. Message 402 corresponds to the message including a request sent from the browser 302 to the content provider 310. Message 404 corresponds to a message including content sent from the content provider 310 to the browser 302 in response to receiving the request. The message 404 can be an asynchronous message such as a notify message of a publish/subscribe protocol. The notify message can be sent as a result of a subscription established as a result of the content provider 310 receiving the message 402 as a subscribe message. Alternately, the message 404 can be a synchronous message such as an HTTP response sent as a result of the content provider 310 receiving the message 402 as an HTTP request message. Message 406 represents an internal message within the browser corresponding to the process described above for presenting the received content via a user interface of the browser 302.

Returning to FIG. 1, in block 104 a selection of at least a portion of the content is received while the user interface is operating in a browsing mode, where the selected content cannot be changed via the user interface. Accordingly, a system for providing a browsing mode association of a link with browsed content includes means for receiving a selection of at least a portion of the content while the user interface is operating in a browsing mode, wherein the selected at least a portion of the content cannot be changed via the user interface. For example, as illustrated in FIG. 2, an input controller component 212 is configured for receiving a selection of at least a portion of the content while the user interface is operating in a browsing mode, wherein the selected at least a portion of the content cannot be changed via the user interface. The message flow diagram of FIG. 4 depicts a message 408 corresponding to receiving a selection of the content presented by the browser 302.

Typical browsers such as MICROSOFT INTERNET EXPLORER and FIREFOX operate by default in browsing mode. Resource editors such as MICROSOFT FRONTPAGE support an editing mode that supports the presentation of content received from a content provider. In browsing mode, the selected content cannot be changed via the user interface of the browser 302. Note that receiving input, such as form input, does not change the content received by the browser 302 from the content provider 310. A second receiving of the content from the content provider 310 can include receiving changed content. However, the change is performed by the content provider 310, not the browser 302.

The displayed content can be selected in a variety of ways known to those skilled in this art. For example, the input controller component 212 can be configured for receiving a selection of at least a portion of the content by receiving a mouse click associated with a displayed object, a pointer dragged over a region associated with the portion of the content, or a key input associated with a portion of the content. The input indicating the selection is received via the input subsystem 320 of the device. Input information is provided to the system input controller component 322 of the browser 302. The system input controller component 322 provides input information to one or more content handlers 200 depending on the content types included in the selection and/or sends input information to the data manager 314 for allowing the data manager 314 to interoperate with the content handlers 200 associated with content in the selected content.

In another example, the input controller component 212 can be configured for receiving a selection of at least a portion of the content by presenting via the user interface of the device 308 and/or the browser 302 an indication of the received selection, the indication identifying the selected content. For example, the presentation manager component 208 can be configured for presenting via the user interface an indication of the received selection. The selected content can be highlighted, for example, by a change in font, a change in color, and/or by outlining the selected content. The highlighting can remain in effect until the operation associated with the selection is completed, as will be described later in this document.

In another example, the input controller component 212 can be configured for receiving a selection of at least a portion of the content by identifying at least one of a tag and an attribute of the selected content, wherein the identified at least one of a tag and attribute is defined in a markup language. A markup language establishes a vocabulary, grammar, and syntax of codes that provide extra information about the content of a resource. The extra information can include, for example, information about the structure of the resource, information about the presentation of the resource, and/or information that constitutes metadata associated with the resource. The codes or elements of a markup language are typically intermingled within the content of a resource. A markup language can provide elements applicable to text, image, video, and/or other forms of data included in and/or referenced by a resource using the markup language. Perhaps the most widely known markup language is HTML, which exists in several versions and variants. Other well-known markup languages (a non-exhaustive list) include standard generalized markup language (SGML) from which HTML is derived, XML, binary XML, DocBook, MathML, RDF, wireless markup language (WML), and synchronized multimedia integration language (SMIL)

A tag as used herein is a markup language label that is recognizable by a markup language processor as markup as opposed to resource content. For example, in XML, tags are indicated by the symbols, ‘<” and ‘>’. Tags can be made up of an opening tag and closing tag as in <p>content</p> where the <p> tag indicates a paragraph and the </p> indicates the end of the paragraph, where <p> is the opening tag and </p> is the closing tag. Everything in between is considered to be content of the <p> tag. Tags can also be expressed as a single unit such as <br/> which in HTML indicates that a line break should be inserted in the content at the location indicated by the <br/> tag. A tag can have one or more attributes that modify the meaning or processing of the tag. For example, <p id=“0001” text=“content”/> is the same <p> tag as before with two attributes. The id attribute provides through an assigned value an identifier for the tag in which it is used. The identifier in the example is “0001” and should be unique for all tags used in the same resource. The text attribute provides an alternate mechanism for providing paragraph content. The value of the text attribute is the paragraph and is equivalent to <p>content</p>. Tags, attributes, values, and the syntactic symbols are all elements of the markup language.

Tags and/or attributes associated with any portion of content in a browsed resource can be identified by the content handler 200 as associated with that specific portion of content. When a selection of content is received, this association of the tag and/or attribute to the selected content can be used to identify which tag and/or attribute corresponds to the selected content. The identity of this tag and/or attribute can be associated with the selection, with this association being used for further processing associated with the selection of the content, as described below.

Returning to FIG. 1, in block 106 an identifier of a resource is received via the user interface, wherein the resource is accessible via the browser but is not linked via the user interface to the portion of the content. Accordingly, a system for providing a browsing mode association of a link with browsed content includes means for receiving an identifier of a resource via the user interface, wherein the resource is accessible via the browser but is not linked via the user interface to the portion of the content. For example, as illustrated in FIG. 2, the input controller component 212 is configured for receiving an identifier of a resource via the user interface. The message flow diagram of FIG. 4 depicts a message 410 for receiving an identifier for accessing a resource.

In one aspect, receiving an identifier of a resource via the user interface includes receiving a uniform resource indicator (URI). For example, the input controller component 212 can be configured for receiving an identifier of a resource via the user interface. The input controller component 212 receives input information indicating that a paragraph displayed as a portion of the content received from the content provider 310 is selected. For example, the content handler 200 of the input controller component 212 can indicate via the presentation manager component 208 of the content controller 200 to the browser that an identifier, such as URL, which is one form of URI, is required to complete the operation in process.

In another aspect, receiving an identifier of a resource via the user interface includes generating a prompt for user entry of the identifier and receiving the identifier via the prompt. For example, the input controller component 212 can be configured for receiving an identifier of a resource via the user interface by generating, via the presentation manager component 208, a prompt for user entry of the identifier and receiving the identifier via the prompt. The browser 302 via the presentation controller 304 and the display subsystem 306 of the device 308 can present a prompt for receiving an identifier. For example, the prompt can be a text box, an instruction, or another presentable indication indicating to a user that an identifier is required.

In another aspect, receiving an identifier of a resource via the user interface includes receiving a user selection of one of a list of identifiers. For example, the input controller component 212 can be configured for receiving an identifier of a resource via the user interface by receiving a user selection of one of a list of identifiers. In an example, the identifier can be selected from a list of bookmarks, a history list, or other presentation of identifiers, such as hyperlinks.

In another aspect, receiving an identifier of a resource via the user interface includes performing a search based on the selected at least a portion of the content and retrieving the identifier as a result of the search. For example, the request builder component 210 can be configured for generating a request for performing a search based on the selected content and retrieving the identifier as a result of the search. The search can also be performed based on a tag and/or an attribute of the selected content, as is described above. Contextual information associated with the selected content can also be used in performing the search. The search returns one or more identifiers for accessing content located as a result of the search. A commercial search engine can be used and/or a private database can be used. The type of search and the search service used can be selected based on the selected content. The search database is depicted as a link library database 220 in FIG. 2.

Those skilled in the art can appreciate that there are various means for receiving an identifier for accessing a resource that can be implemented. In one aspect, an identifier is determined that is associated with a second resource displayed via the user interface of the browser. For example, the input controller component 212 can be configured for determining an identifier associated with a second resource displayed via the user interface of the browser. In particular, an identifier of a second presentation of content received from a content provider that is displayed by the user interface of the browser 302 concurrently with the selected content can be automatically associated. The second displayed resource can be presented via the browser 302, for example, in another window, tab, or pane.

In another aspect, receiving an identifier of a resource via the user interface includes receiving an identifier configured for accessing a resource accessible via at least one of a get-request protocol and a publish-subscribe protocol. For example, the request builder component 210 can be configured for accessing the resource via at least one of a get-request protocol, such as HTTP, and a publish-subscribe protocol, such as a XMPP. In an example, the identifier can be received by determining a URL for the next resource that is retrieved and presented in the browser 302. The next resource can be retrieved as a result of a user browsing to the resource or by some automated process.

In another aspect, the selection for providing an identifier can be from the same content with which the identifier is to be associated. That is, the selected content can be associated with an identifier that causes the selected content to link to itself using the technique discussed further below.

Returning to FIG. 1, in block 108 the at least a portion of the content is associated with the identifier without changing the selected content, thereby enabling the at least a portion of the content to operate as a link for accessing the resource via the user interface. Accordingly, a system for providing a browsing mode association of a link with browsed content includes means for associating the at least a portion of the content with the identifier without changing the selected at least a portion of the content, thereby enabling the at least a portion of the content to operate as a link for accessing the resource via the user interface. For example, as illustrated in FIG. 2, a link service component 214 is configured for associating the at least a portion of the content with the identifier without changing the selected at least a portion of the content. The message flow diagram of FIG. 4 depicts a message 412 corresponding to creating an association of the selected content with the identifier and a message 414 sent to a link service component 214 for storing the association in a link database 218.

The association of the selected content with an identifier is made without changing the selected content received by the browser 302 from the content provider 310. The association of the identifier with the selected content enables the selected content to operate as a link based on the identifier for access a resource via the user interface of the browser. Those skilled in the art will see that input indicating an identifier can be received prior to receiving the selection of the content to be associated with the identifier and also will be able to see that an identifier can be determined prior to and/or during the selection of the content for automatic association.

The link service component 214 is configured to receive information associated with a least a portion of content presented by a user interface of the browser 302. The browser 302 is operating in a browsing mode where, as previously described, the at least a portion of the content cannot be changed by the browser 302. For example, the browser 302 can receive content from the content provider 310 where at least a portion of the content is associated with an identifier for locating a resource and where the association is not included in the content. In the example, the association is stored in the link database 218 either local or remote to the device 308. Upon receiving the content, attribute information of the content such as the URI of the content, for example, is sent to the link service component 214.

In one aspect, the selection of content and the determination of an identifier to associate with the content are both performed automatically based on behaviors and/or attributes of the user and/or the content. For example, a browser can be configured to associate each presented page and/or tab with an identifier of a next presented page and/or tab and storing the associations. Thus, a user at any time in the future can replay a web session by using each page and/or tab as a link to the next page and/or tab. The presentation can be automated like a slideshow.

In another aspect, associating the at least a portion of the content with the identifier includes saving an association in a link database 218. For example, both the selection of the content and the identifier can be provided to the link service component 214 for creating an association and the link service component 214 can be configured for associating the selected content with the identifier by saving an association in the link database 214. The link service component 214 creates the association and invokes a link manager 216 configured to store the association in a link database 218.

FIG. 3 depicts various options for providing a link library 220 and a link database 218. In one aspect, the browser 302 can interoperate with a link database 218A and/or a link library 220A for maintaining the set of private associations and/or a private library of identifiers for associating with selected content. In another aspect, one or both of the link database 218 and the link library 220 can be provided by a remote service independent of the content provider 310. For example, the link library 220B can be a network search engine and a service provider can provide a link service component 214 serving multiple clients, the service being depicted as a link database 218B in FIG. 2. In yet another aspect, the content provider 310 can also provide a link service component 214 including a link database 218C and/or a link library 220C. In one example, the content provider 310 provides a link library 220C that indexes the content provider's content. Similarly, the content provider 310 can provide a link database 218C that manages associations, which can include only associations that include content selections of the content provider's content and/or associations including identifiers for accessing the content provider's content.

Those skilled in the art will appreciate that a combination of these aspects can be employed, including the use of multiple content providers' link libraries 220C and link databases 218C, third party link libraries 220B and link databases 218B, and multiple private link libraries 220A and/or link databases 218A. Further, at least a portion of the link databases 218 and the link libraries 220 can interoperate to enable, for example, a user to access her/his private associations from any location or to perform distributed searches of link libraries 220. Still further, associations can be shared among clients. For example, a first user when visiting a banking site can configure her/his browser 302 to use associations created by a known financial expert so the user can select identifiers for accessing resources that the financial expert has associated with selected portions of the content of the banking site.

The link service component 214 includes the link manager 216 configured to locate one or more associations between at least a portion of the content and an identifier for locating a resource. The link manager 216 can be configured to perform a search of the associations in the link database 218 based on, for example, the URI of the content presented in the browser 302, a tag and/or attribute associated with the at least a portion of the content, and/or a path identifier identifying a location of the at least a portion of the content in the content.. The search returns one or more associations including the portion of content presented. The link service component 214 is configured to provide the association(s) located to the content handler 200 compatible with a content type of a portion of the content included in a located association. The associations can be sent to any browser 302 via the network 312 for delivery to a content handler 200 from a remote link service component 214. Alternatively or additionally, the link service component 214 returns a located association to one or more content handlers 200 based on the content type(s) included in the association. The providing of the associations to the content handler(s) 200 can be performed by the data manager 314 in one aspect. A content handler 200 is configured to receive input via the input controller component 212 in a manner analogous to that described above for receiving input associated with a portion of the content included in a received association. The input controller component 212 and a browser portion of the link service component 214 can be configured to determine whether the input indicates an activation of the identifier included in the located association. When the input controller component 212 and the client portion of the link service component 214 determine that the received input indicates an activation of the identifier, the client portion of the link service component 214 instructs the request builder component 210 to initiate generating a request based on the identifier included in the association. The request is sent in a message for accessing the resource identified by the identifier to a content provider identifiable by the identifier. The building of the request and sending the message is discussed above, as is the receiving and presenting of the content included in the accessed resource.

The message flow diagram of FIG. 4 depicts a message 416 to the content provider 310 for retrieving the content a second time. A message 418 illustrates browser 302 receiving the content a second time. The message 420 illustrates a request to the link service component 214 for locating associations including a reference to a portion of the content received. The message 422 illustrates a content handler 200 receiving an association from the link service component 214. The message 424 illustrates a message corresponding to an input received by the content handler indicating the identifier included in the received association is to be activated. The message 426 depicts the browser 302 requesting the resource identified by the identifier included in the association.

In another aspect, access to the stored association by other browsers is limited based on a profile that includes limitations based on a user, a group, a browser type, a client device, a time, a date, a geographic region, a task or a workflow. For example, the link service component 214 can be configured for limiting access to the stored association by other browsers based on a profile that includes limitations based on a user, a group, a browser type, a client device, a time, a date, a geographic region, a task or a workflow. In an example, associations can be private to a user or can be configured to be available to users in a specified group. In another example, some associations can be made available only to browsers that operate on a handheld device as they may be useful and/or viewable only on a small display. In another aspect, associations can be made available according to a geographic location such as a geographic location of the client. Thus, the links have a relationship to the geographic region including the geographic location. In yet another aspect, a user can be engaged in a task, such as a task, thus, the associations used can be configured to be associations related to the task, thereby making browsing specific to the task.

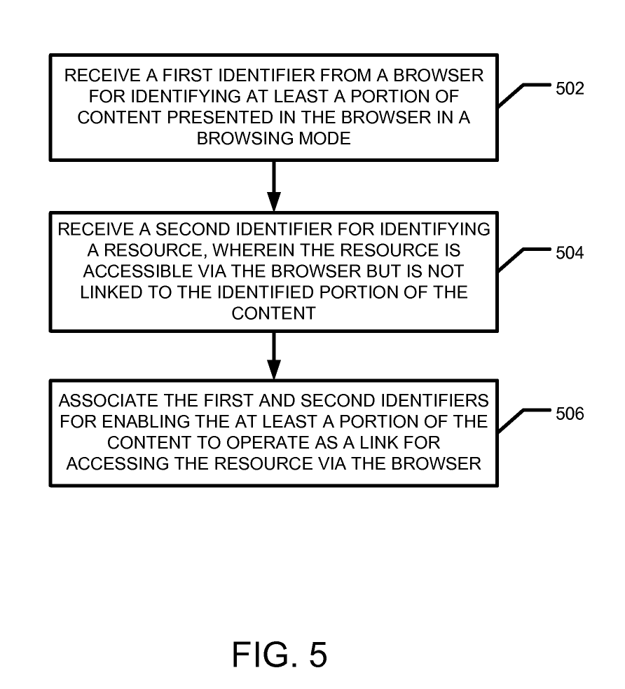

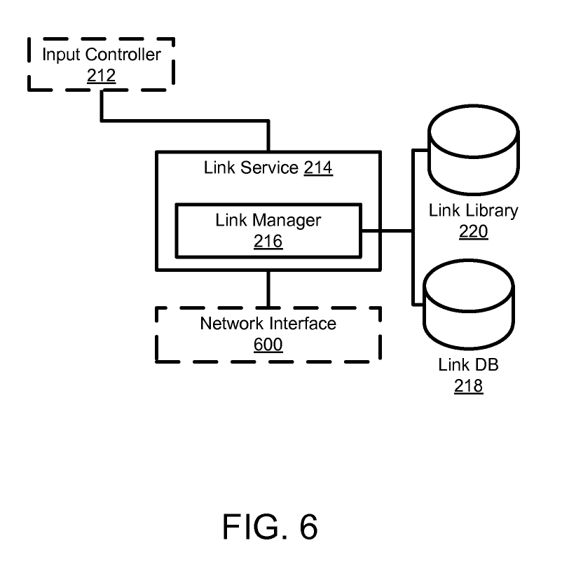

FIG. 5 is a flow diagram illustrating a method for providing a browsing mode association of a link with browsed content according to an exemplary aspect of the subject matter described herein. FIG. 6 is a block diagram illustrating a system for providing a browsing mode association of a link with browsed content according to another exemplary aspect of the subject matter described herein. The method illustrated in FIG. 5 can be carried out by, for example, some or all of the components illustrated in the exemplary system of FIG. 6.

With reference to FIG. 5, in block 502 a first identifier is received from a browser for identifying at least a portion of content presented in the browser in a browsing mode. Accordingly, a system for providing a browsing mode association of a link with browsed content includes means for receiving a first identifier from a browser for identifying at least a portion of content presented in the browser in a browsing mode. For example, as illustrated in FIG. 6, the link service 214 is configured for receiving a first identifier from a browser for identifying at least a portion of content presented in the browser in a browsing mode. In an aspect, where a portion of the link service 214 is included in a browser, the first identifier can be received by the link service 214 via the input controller 212 as described above with respect to receiving a selection of the at least a portion of the content. In another aspect, where a portion of the link service 214 is operating on a networked device other than the device associated with the browser, the first identifier can be received by the link service 214 via a network interface 600. The network interface, in an aspect, can be similar to the network subsystem describe with respect to the system depicted in FIG. 3.

In block 504 a second identifier for identifying a resource is received, wherein the resource is accessible via the browser but is not linked to the identified portion of the content. Accordingly, a system for providing a browsing mode association of a link with browsed content includes means for receiving a second identifier for identifying a resource, wherein the resource is accessible via the browser but is not linked to the identified portion of the content. For example, as illustrated in FIG. 6, the network link service 214 is configured for receiving a second identifier for identifying a resource. In an aspect, where a portion of the link service 214 is included in a browser, the second identifier can be received by the link service 214 via the input controller 212 as described above with respect to receiving an identifier of a resource. In another aspect, where a portion of the link service 214 is operating on a networked device other than the device of the browser, the second identifier can be received by the link service 214 via the network interface 600. The first and second identifiers can be received in a single message or separate messages via the network interfaces. The messages can conform to a get-request (synchronous) protocol or a publish/subscribe (asynchronous) protocol.

The network interface component 600 illustrated can include all the hardware, firmware, and software necessary, such as the network stack 324 and corresponding network layer support 316, 318 discussed above, to carry out communications with the network 312 using any one or more of a number of known protocols, such as those discussed above.

As discussed above, the first and second identifiers are provided by the browser 302 to a remote link service component 214 via the network interface component 600 for storage in a link library 220 and/or link database 218. An exemplary message is illustrated by message 414 of FIG. 4. Although a single message is shown by way of example, the identifiers can be received in multiple messages, in separate messages, or in the same single message. Where multiple messages are employed, no particular order need be required. In a local link service 214 included in the browser 302 the message 414 can correspond to a message communicated within the device 308 such as function call, an event, a queue message, and/or an interrupt.

As discussed above, there are several aspects for receiving the first and/or second identifiers, including receiving a uniform resource indicator (URI), performing a search based on the identifier and/or the content and retrieving the second identifier as a result of the search, and determining an identifier associated with a second resource displayed by the browser.

Returning to FIG. 5, in block 506 the first and second identifiers are associated for enabling the at least a portion of the content to operate as a link for accessing the resource via the browser. Accordingly, a system for providing a browsing mode association of a link with browsed content includes means for associating the first and second identifiers for enabling the at least a portion of the content to operate as a link for accessing the resource via the browser. For example, as illustrated in FIG. 6, a link manager component 216 is configured for associating the first and second identifiers for enabling the at least a portion of the content to operate as a link for accessing the resource via the browser. The link service component 214 provides the received first and second identifiers to the link manager component 216. In an aspect, the link manager component 216 is included in the link service component 214. In another aspect, the link manager component 216 is separate but operatively coupled to the link service component 214. In a further aspect, each of the link service 214 and the link manager 216 components have a browser-based portion and a remote portion operating on a remote network device. In yet another aspect, the link service component 214 is included in a content handler 200 and the link manager component is hosted on a remote device.

In one aspect, associating the at least a portion of the content with the identifier can include saving an association in the link database 218, as described above. For example, the link manager component 216 can be configured for associating the at least a portion of the content with the identifier by saving an association in the link database 218.

In another aspect discussed above, the stored association can be made available to other browsers. For example, the link service component 214 can be configured for making the stored association available to other browsers.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g), or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing a browsing mode association of a link with browsed content, the method comprising:
receiving content from a content provider for display via a user interface of a browser;
receiving a selection of at least a portion of the content while the user interface is operating in a browsing mode, wherein the selected at least a portion of the content cannot be changed via the user interface;
receiving an identifier of a resource via the user interface, wherein the resource is accessible via the browser but is not linked via the user interface to the portion of the content; and
associating the at least a portion of the content with the identifier without changing the selected at least a portion of the content, thereby enabling the at least a portion of the content to operate as a link for accessing the resource via the user interface.

2. The method of claim 1 wherein receiving a selection of at least a portion of the content includes at least one of:
identifying at least one of a tag and an attribute of the selected at least a portion of the content, wherein the identified at least one of a tag and attribute is defined in a markup language; and
presenting via the user interface an indication of the received selection, the indication identifying the selected at least a portion of the content.

3. The method of claim 1 wherein receiving an identifier of a resource via the user interface includes receiving a uniform resource indicator (URI).

4. The method of claim 1 wherein receiving an identifier of a resource via the user interface includes generating a prompt for entry of the identifier and receiving the identifier via the prompt.

5. The method of claim 1 wherein receiving an identifier of a resource via the user interface includes receiving a selection of one of a list of identifiers.

6. The method of claim 1 wherein receiving an identifier of a resource via the user interface includes performing a search based on the selected at least a portion of the content and retrieving the identifier as a result of the search.

7. The method of claim 1 wherein receiving an identifier of a resource via the user interface includes determining an identifier associated with a second resource displayed via the user interface of the browser.

8. The method of claim 1 wherein receiving an identifier of a resource via the user interface includes receiving an identifier configured for accessing a resource accessible via at least one of a get-request protocol and a publish-subscribe protocol.

9. The method of claim 1 wherein associating the at least a portion of the content with the identifier includes saving an association in a link database.

10. The method of claim 9 wherein the stored association is made available to other browsers.

11. The method of claim 10 wherein access to the stored association by other browsers is limited based on a profile that includes limitations based on at least one of a user, a group, a browser type, a client device, a time, a date, a geographic region, a task and a workflow.

12. A method for providing a browsing mode association of a link with browsed content, the method comprising:
receiving a first identifier from a browser for identifying at least a portion of content presented in the browser in a browsing mode;
receiving a second identifier for identifying a resource, wherein the resource is accessible via the browser but is not linked to the identified portion of the content; and
associating the first and second identifiers for enabling the at least a portion of the content to operate as a link for accessing the resource via the browser.

13. The method of claim 12 wherein receiving a second identifier for identifying a resource includes receiving a uniform resource indicator (URI).

14. The method of claim 12 wherein receiving a second identifier for identifying a resource includes performing a search based on at least one of the first identifier and the at least a portion of the content and retrieving the second identifier as a result of the search.

15. The method of claim 12 wherein receiving a second identifier for identifying a resource includes determining an identifier associated with a second resource displayed by the browser.

16. The method of claim 12 wherein associating the at least a portion of the content with the identifier includes saving an association in a link database.

17. The method of claim 16 wherein the stored association is made available to other browsers.

18. A system for providing a browsing mode association of a link with browsed content, the system comprising:
means for receiving content from a content provider for display via a user interface of a browser;
means for receiving a selection of at least a portion of the content while the user interface is operating in a browsing mode, wherein the selected at least a portion of the content cannot be changed via the user interface;
means for receiving an identifier of a resource via the user interface, wherein the resource is accessible via the browser but is not linked via the user interface to the portion of the content; and
means for associating the at least a portion of the content with the identifier without changing the selected at least a portion of the content, thereby enabling the at least a portion of the content to operate as a link for accessing the resource via the user interface.

19. A system for providing a browsing mode association of a link with browsed content, the system comprising:
a content interpreter component configured for receiving content from a content provider for display via a user interface of a browser;
an input controller component configured for receiving a selection of at least a portion of the content while the user interface is operating in a browsing mode, wherein the selected at least a portion of the content cannot be changed via the user interface;
the input controller component configured for receiving an identifier of a resource via the user interface, wherein the resource is accessible via the browser but is not linked via the user interface to the portion of the content; and
a link service component configured for associating the at least a portion of the content with the identifier without changing the selected at least a portion of the content, thereby enabling the at least a portion of the content to operate as a link for accessing the resource via the user interface.

20. The system of claim 19 wherein the input controller component is configured for receiving a selection of at least a portion of the content by identifying at least one of a tag and an attribute of the selected at least a portion of the content, wherein the identified at least one of a tag and attribute is defined in a markup language.

21. The system of claim 19 comprising a presentation manager component configured for presenting via the user interface an indication of the received selection, the indication identifying the selected at least a portion of the content.

22. The system of claim 19 wherein the input controller component is configured for receiving an identifier of a resource via the user interface by receiving a uniform resource indicator (URI).

23. The system of claim 19 wherein the input controller component is configured for receiving an identifier of a resource via the user interface by generating, via a presentation manager, a prompt for entry of the identifier and receiving the identifier via the prompt.

24. The system of claim 19 wherein the input controller component is configured for receiving an identifier of a resource via the user interface by receiving a selection of one of a list of identifiers.

25. The system of claim 19 comprising a request builder component configured for generating a request for performing a search based on the selected at least a portion of the content and retrieving the identifier as a result of the search.

26. The system of claim 19 comprising a request builder component configured for accessing the resource via at least one of a get-request protocol and a publish-subscribe protocol.

27. The system of claim 19 wherein the input controller component is configured for receiving an identifier of a resource via the user interface by determining an identifier associated with a second resource displayed via the user interface of the browser.

28. The system of claim 19 wherein the link service component is configured for associating the at least a portion of the content with the identifier by saving an association in a link database.

29. The system of claim 28 wherein the link service component is configured for making the stored association available to other browsers.

30. The system of claim 29 wherein the link service component is configured for limiting access to the stored association by other browsers based on a profile that includes limitations based on at least one of a user, a group, a browser type, a client device, a time, a date, a geographic region, a task and a workflow.

31. A system for providing a browsing mode association of a link with browsed content, the system comprising:
means for receiving a first identifier from a browser for identifying at least a portion of content presented in the browser in a browsing mode;
means for receiving a second identifier for identifying a resource, wherein the resource is accessible via the browser but is not linked to the identified portion of the content; and
means for associating the first and second identifiers for enabling the at least a portion of the content to operate as a link for accessing the resource via the browser.

32. A system for providing a browsing mode association of a link with browsed content, the system comprising:
a link service component configured for receiving a first identifier from a browser for identifying at least a portion of content presented in the browser in a browsing mode and for receiving a second identifier for identifying a resource, wherein the resource is accessible via the browser but is not linked to the identified portion of the content; and
a link manager component configured for associating the first and second identifiers for enabling the at least a portion of the content to operate as a link for accessing the resource via the browser.

33. The system of claim 32 further comprising a network interface component configured for receiving at least one of the first identifier and the second identifier

34. The system of claim 33 wherein the network interface component is configured for receiving the second identifier for identifying the resource by receiving a uniform resource indicator (URI).

35. The system of claim 32 comprising a search engine configured for performing a search based on at least one of the first identifier and the at least a portion of the content and retrieving the second identifier as a result of the search.

36. The system of claim 32 wherein the link service component is configured for receiving a second identifier for identifying a resource by determining an identifier associated with a second resource displayed by the browser.

37. The system of claim 32 wherein the link manager component is configured for associating the at least a portion of the content with the identifier by saving an association in a link database.

38. The system of claim 37 wherein the link service component is configured for making the stored association available to other browsers.

39. A computer readable medium including a computer program, executable by a machine, for providing a browsing mode association of a link with browsed content, the computer program comprising executable instructions for:
receiving content from a content provider for display via a user interface of a browser;
receiving a selection of at least a portion of the content while the user interface is operating in a browsing mode, wherein the selected at least a portion of the content cannot be changed via the user interface;
receiving an identifier of a resource via the user interface, wherein the resource is accessible via the browser but is not linked via the user interface to the portion of the content; and
associating the at least a portion of the content with the identifier without changing the selected at least a portion of the content, thereby enabling the at least a portion of the content to operate as a link for accessing the resource via the user interface.

40. A computer readable medium including a computer program, executable by a machine, for providing a browsing mode association of a link with browsed content, the computer program comprising executable instructions for:
receiving a first identifier from a browser for identifying at least a portion of content presented in the browser in a browsing mode;
receiving a second identifier for identifying a resource, wherein the resource is accessible via the browser but is not linked to the identified portion of the content; and
associating the first and second identifiers for enabling the at least a portion of the content to operate as a link for accessing the resource via the browser.
